(19) United States
(12) Patent Application Publication
(10) Pub. No.: US 2009/0194136 A1
(43) Pub. Date: Aug. 6, 2009

(54) DEVICE FOR CLEANING CONTAINERS

(76) Inventors: David Tsutoma Yamashiro, JR., (US); Bradly James Edgerton, (US); Rae Packer, (US)

Correspondence Address: David E. Orr, 4616 NE 134th. Street, Vancouver, WA, 98686, US

(21) Appl. No.: 12/316,052

(22) Filed: Dec. 8, 2008

Related U.S. Application Data
(63) Continuation-in-part of application No. 12/012,304, filed on Feb. 1, 2008, now abandoned.

(51) Int. Cl. A47L 25/00; B08B 1/00

(52) U.S. Cl. 134/8; 15/211

(57) ABSTRACT

A hollow ware scrubber comprised of an elongated tube of material having weighted balls or objects, the tube sealed on its' ends. The scrubber can be easily passed through the narrow opening of jars, bottles, wine decanters, vases, or other hollow ware. When the scrubber is inside of hollow ware, and the hollow ware is shaken or agitated, the scrubber comes into contact with the inside surfaces of the hollow ware and cleaning or polishing of the surfaces occurs. The scrubber may also be furnished with a cleaning solution inside the tube or infused in the tube. When scrubber is inserted into an object to be cleaned, cleaning solution is released from the scrubber and facilitates cleaning. A scrubber can be made in decorative shapes and various thicknesses and lengths, as long as the scrubber is conformable and adapts to the inside of the object to be cleaned.

### RELATED APPLICATIONS

This application is a CIP of U.S. patent application Ser. No. 12/012,304, filed on Apr. 4, 2003 entitled DEVICE FOR CLEANING, DRYING AND POLISHING CONTAINERS, and which is incorporated herein by reference.

### FIELD OF INVENTION

This invention relates to cleaning devices, specifically those devices used to clean the inside of hollow containers.

### BACKGROUND

Cleaning the inside of bottles and vases and other hollow ware is a difficult task. While cleaning utensils can be easily manipulated to wash the outside of most containers it is difficult to access the inside of containers using standard cleaning tools such as brushes or scrubbing cloths. Containers that have narrow necks such as wine decanters, canteens, thermoses, or vases present the greatest challenge since traditional cleaning brushes that are small enough to fit through the narrow neck do not have enough bulk to reach all of the inside areas that need cleaning.

In addition to the problems recited above, brushes cannot be readily manipulated from outside of narrow necked hollow ware to achieve an effective scrubbing action since the scrubbing pressure cannot be easily directed or controlled. Most of the cleaning pressure is applied to the tip of the brush not to the bristles along the shaft of the brush. Even with considerable pressure and scrubbing action the inside corners of hollow containers may not be reached at all by the bristles of a conventional bottlebrush.

A wide variety of specialty brushes have been developed in attempts to overcome the limitations of conventional brushes for hollow ware with narrow openings. Typical of this group of brushes are U.S. Pat. No. 2,513,719 to Martin T. Glass (1950), U.S. Pat. No. 3,451,723 to Theodore Marks (1969), U.S. Pat. No. 2,675,572 to Frank K. Nomiya (1954), U.S. Pat. No. 1,652,213 to Wyllis F. Pulver (1927), and others. While these brushes may improve on the standard bottlebrush, they still all have limitations with respect to the size and shape of the container they can be used to clean, and or the effectiveness of manipulating the cleaning surface inside the vessel using a handle outside of the vessel.

Other systems have been proposed that make use of a sponge instead of a bristled brush for cleaning. U.S. Pat. No. 6,298,515 to Bessie Jane Robinson (2000) is constructed by surrounding a rigid rod with a sponge or compressible foam, which can be covered with a variety of scrubbing surfaces. Robinson's cleaning instrument works by compressing the sponge to get through the narrow opening of a bottle or vase and then it expands once inside the hollow container to provide an effective cleaning surface. This instrument will work well with hollow containers of fairly uniform shape but may not clean irregular shapes well. Because of the bulk of the sponge and the rigid non-compressible rod at its' center this instrument may not be effectively inserted into containers with very small openings.

Other systems have been developed for the commercial cleaning of large numbers of hollow containers. In U.S. Pat. No. 5,487,200, Kenneth J. Herzog (1996) discloses a mechanical conveyor that moves bottles through a number of cleaning stations that may use vacuum, ionized air, pressurized air, water, or other cleaning solutions. This type of cleaning system is not practical for non-industrial settings.

In U.S. Pat. No. 251,323, Charles Vonderlinden (1881) describes a tool developed to clean the inside of barrels and casks without removing their heads. The tool consists of a series of metal balls or blocks with projecting bristles that are connected together with chain or rope. To clean the inside of a barrel, water or cleaning solution is poured into the barrel through the bunghole, and then the connected balls with integral bristles are passed through the bung-hole and moved about. The force of the bristles rubbing against the inside of the barrel as the barrel is moved, or the chain of balls is passed in and out of the barrel, scrubs the inner walls of the barrel.

Although the above invention is proposed for cleaning large barrels, casks, and the like, at least one subsequent U.S. Pat. No. 1,350,807 to Edith A. Jackson (1920) is very similar and incorporates the same chain and ball/bristle concept. The U.S. Pat. Nos. 251,323 and 1,350,807 both rely on the connection of a number of cleaning balls with bristles by a chain or other flexible means. This chain of cleaning balls is placed into a hollow container along with the desired cleaning solution and vigorously shaken to produce an effective scrubbing action. While these cleaning devices may appear effective they actually have only limited cleaning potential. The scrubbing surface of these devices is limited to a small number of bristles that can be attached to weighted balls and their connecting chain. These devices also pose a significant risk of cracking or damaging fragile and delicate containers.

Furthermore, cleaning mechanisms that depend on weighted balls that are chained or connected together are frequently difficult to remove from narrow necked containers due to kinking or tangling of the chain inside the container during the cleaning operation. When these cleaning mechanisms becomes tangled inside the container they may be impossible to remove without damaging the container. If the chain is too long it will easily become tangled during the cleaning operation, if the chain is too short the limited number of cleaning balls and bristles will make the cleaning operation ineffective.

Various bottle cleaners have been proposed that rely on the use of chains and balls for cleaning. The U.S. Pat. No. 264,123 to William C. Baldwin (1882) incorporates a cleaning rod or shaft with bristled tip and a number of chains that are placed perpendicularly along the rod. When the rod is placed in a bottle the bristled tip cleans the bottom and rotation of the rod generates sufficient centrifugal force of the chains against the inner walls of the vessel to clean them. This device will have the same cleaning limitation as any chain type system, that is, a reduced scrubbing surface, and will be of limited used for containers with diameters that significantly exceed the length of the chains. In addition, the central shaft used to suspend the chains will not allow the use of this device on many small mouth containers since opening of the container must be large enough to accommodate the width of the shaft and the bulk of the chains.

The U.S. Pat. No. 392,102 to Walter D. Butz (1888) and U.S. Pat. No. 700,499 to David H. Irving and Jonathan Chase (1902) are typical of chain-type cleaners that have integrated a stopper at the top of the cleaning chain. The use of a stopper to plug the mouth of the vessel being cleaned and to anchor the cleaning chain on one end significantly may limit the shapes and sizes of hollow ware that can be cleaned. Once again the chain may not effectively reach all areas of the container, especially if the container is irregular in shape. This device may also require changing the size of the stopper to accommodate vessels with wide or narrow openings.

The U.S. Pat. No. 878,768 to William H. Callahan (1908) consists of a number of ceramic or glass balls attached to a string, enclosed in a fabric bag, and suspended from a stopper. The string with the balls is anchored at the top by a hook placed through the stopper and on the bottom by attachment to the bag it is suspended in. Stoppers of different diameters can be used to accommodate vessels with wide or narrow openings. While this device does provide a greater scrubbing surface than devices that utilize only a chain, the length of the sack limits the height and shape of the containers that may be cleaned; in particular this device will not clean vessels with irregular shapes. It should also be noted that by suspending the ceramic balls in a loose bag, the pressure of the material against the inner wall of the vessel being cleaned will vary greatly and thus its' effectiveness will also vary greatly.

With prior art cleaning devices in mind, we have invented a novel cleaner or scrubber that does not have the inherent limitations recited.

### SUMMARY

The present invention comprises a scrubber for cleaning the inside of containers. The scrubber comprises weighted balls or other weighted objects that are encased in an elongated tube of material closed on both ends. The elongated tube can vary in length and diameter, and may be square, round or may be of a decorative shape, or irregular shape, but the proportions should be compatible with the proportions of the objects within the tube, that is, the tube is conformable to the inside surface of the container.

The elongated tube is fabricated from a variety of textured or smooth materials to suit the cleaning purpose. The scrubber has dimensions so that it can easily be placed through openings of vases, bottles, or other vessels along with a chosen cleaning solution, the lid covered with a stopper or the hand, and then swished or swirled around to produce an effective scrubbing action as the scrubber and cleaner come into contact with the inside walls of the vessel.

Various aspects of the invention will be seen to have a number and advantages and benefits when compared to prior art cleaning systems and mechanisms.
a. It is narrow and flexible enough to easily fit through the smallest container opening while providing a very large scrubbing surface.
b. It may also be used on hollow ware with large mouth openings such as jars.
c. Its shape may be long, cylindrical, rectangular, or irregular, as appropriate for use with hollow ware with large openings.
d. It is flexible over its' entire length and therefore can reach and clean even the most irregular inside surfaces.
e. The support provided by the tube covering the weighted balls keeps the scrubber from becoming tangled while inside of a container being cleaned.
f. The scrubber can be filled with any number, size, weight, or shape objects which allows variation of the pressure or scrubbing action that it exerts against the inside surfaces of a hollow vessel.
g. The texture or composition of the tube of material covering the scrubber can be changed to achieve effects that vary from very coarse scrubbing to drying or polishing.
h. The use of a sock or tube of material covering the balls or weighted objects cushions the impact of the balls against the inside walls of fragile containers, such as glass vases, and prevents cracking or chipping.
i. The scrubber is simple to construct, low in cost and may be used in commercial and non-commercial cleaning applications.
j. The scrubber can be filled with, or contain soap or cleaning agents in addition to the balls or weighted objects to further enhance its cleaning effectiveness.

Further objects and advantages of my invention will become apparent from a consideration of the drawings and ensuing description.

### BRIEF DESCRIPTION OF THE DRAWINGS

FIG. 1A is a view of a hollow ware scrubber embodying features of the present invention. In this illustration, the scrubber is shown with a rough textured surface; variations include surfaces having bristles, or smooth surfaces for absorbing moisture or surfaces capable of polishing hollow ware.

FIG. 1B shows a scrubber comprising a sock, or tube, the sock or tube having masses—in this case spherical masses, and having a cleaner within the sock or tube.

FIG. 1C shows a scrubber having spherical masses, but of smaller diameter, and also having cleaner.

FIG 1D shows a cross section of a scrubber having a spherical mass, and having cleaner.

FIG. 1E shows a scrubber with large spherical masses and granules of soap or cleaner inside the sock.

FIG. 1F shows a scrubber with small spherical masses and granules of soap or cleaner inside the sock.

FIG. 2A illustrates how the scrubber of FIG. 1 is inserted into a hollow vessel.

FIG. 2B shows the hollow vessel being manually agitated, causing the scrubber to scour, clean, polish or dry the inside of the vessel.

FIG. 3 is a graph showing the relationship of scrubber flexibility versus length for various combinations of tube or sock knot density and tube seam configuration.

FIG. 4 is a graph showing the relationship of scrubber propensity to tangle versus length for various combinations of tube or sock knot density and tube seam configuration.

FIG. 5 is a graph showing the relationship of scrubber flexibility, represented as percentage of tangle or arc versus length for various combinations of tube or sock knot density and tube seam configuration.

FIG. 6 is a graph showing the relationship of scrubber flexibility versus scrubber wear.

### DETAILED DESCRIPTION

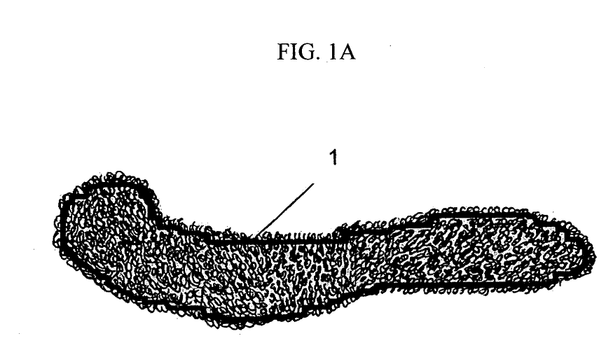

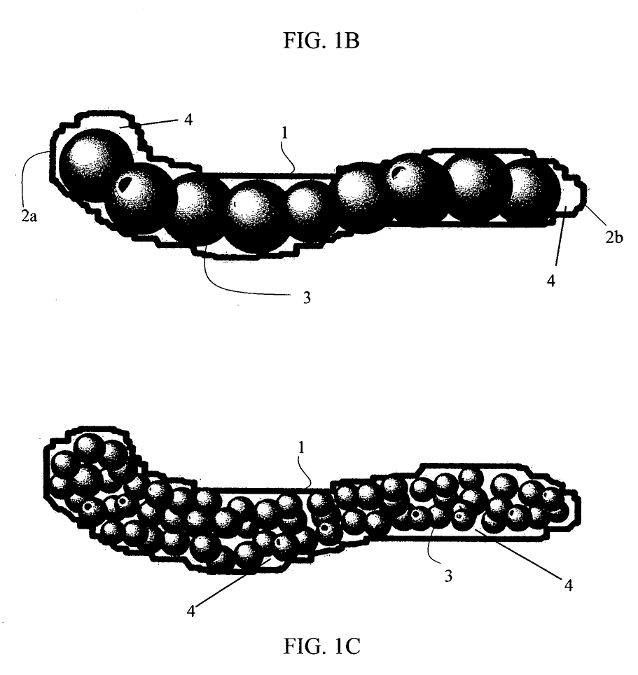

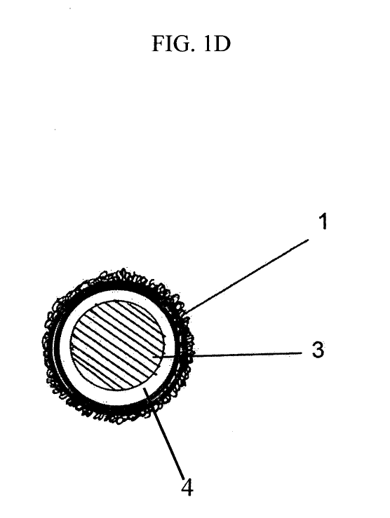

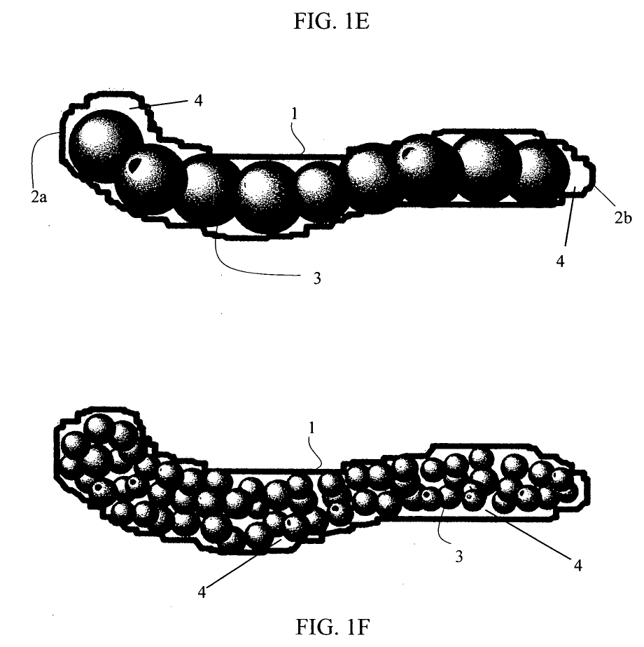

A hollow ware scrubber 1 embodying features of the present invention is illustrated in FIG. 1A. With reference to FIG. 1B the scrubber comprises an elongated tube of material—a sock, or sheath or bag—1 filled with weighted objects 3 or other objects and sealed on its ends 2a, 2b. The elongated tube also has a cleaner or cleaning material 4 inside. The elongated tube 1 is fabricated from a wide range of materials, such as plastic (nylon, rayon, polyester, acrylic copolymer, homo-polymer, etc.), natural woven fibers, artificial woven fibers, and stainless steel net. The elongated tube 1 is formed by fabrication means that is practical and cost effective; the elongated tube 1 may be closed on the ends 2a, 2b using permanent methods such as sewing, melting or gluing, or with less permanent methods, such as hook-and-loop fasteners. Various esthetic designs or ornamentations may be applied or the scrubbers appearance may be modified to enhance its' consumer appeal. The surface of the tube has a textured surface, or abrasive surface of has bristles for cleaning and scouring. Or the tube is made from a soft material or an absorbent material for the purpose of drying or polishing hollow ware.

With reference to FIG. 1B, FIG. 1C and FIG. 1D, the elongated tube 1 is made of sufficient diameter to accommodate the weighted balls 3, or other masses that are placed inside of it, limiting the movement of the objects in the tube. Cleaner or cleaning material 4 comprises a detergent, surfactants or other substances used to clean or wash dishes and glassware. With reference to FIG. 1B the weighted ball(s) 3, fit tightly into the tube, but not so tightly that the tube is overly stiff. The tube must be flexible enough to bend and conform to the shapes of the surfaces it must clean but not so flexible that it can get tangled in use. Other tube shapes may be used as long as the shape does not limit the tube's movement, and the tube is conformable with the inside surface of the object being cleaned.

With reference to FIG. 1E, and FIG. 1F, the tube may contain or be saturated with soap, and other cleaning or scrubbing agents, whereby the soap and cleaning agents are released to enhance the cleaning action of the scrubber.

### Scrubber Objects

A variety of objects were used to make various types of scrubbers. The type of object material and object mass depends upon the nature, or construction of the hollow ware or containers cleaned, scrubbed or polished. Objects used in test scrubbers were smooth, some being spherical and were constructed from steel, titanium, glass, ceramic, zinc, pewter and coated lead. For most hollow ware used with the scrubber, objects having a combined mass of at least ten grams were required for adequate scrubbing or polishing. However, it will be appreciated that a mass less than ten grams would be more effective for delicate or fragile hollow ware.

When spherical objects were employed in the scrubber, a diameter ranging from four millimeters to ten millimeters was found to be adequate for a wide range of different kinds of hollow ware. However, it will be appreciated that other diameters could prove to be effective for hollow ware that was not tested.

### Using the Scrubber

The scrubber is inserted into the opening of a bottle, vase, or other hollow object, along with a cleaning solution, or the scrubber having included cleaning solution is inserted into the object to be cleaned. When the hollow object is shaken the scrubber will exert sufficient scrubbing action against the inside surfaces of the object to provide very effective cleaning. When the scrubber has included cleaning solution, shaking or agitation will cause the cleaning solution to be released from the scrubber.

It should also be noted that the scrubber tube can be fabricated from an absorbent or smooth cloth to provide a drying or polishing effect on the inside surfaces of hollow ware. This may be particularly useful to remove water spots or mineral deposits from clear vases or carafes.

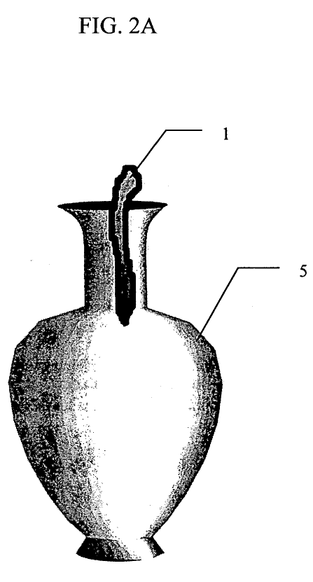

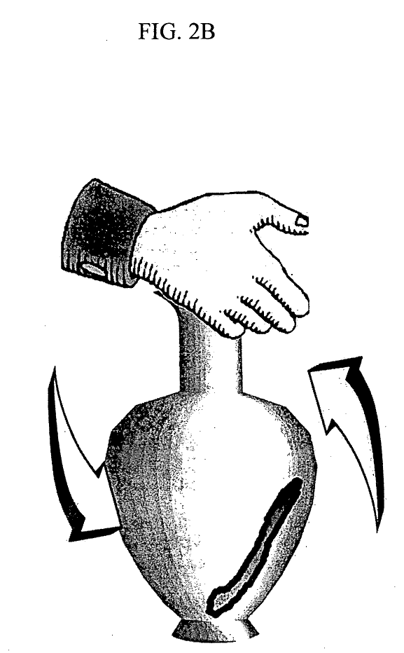

FIG. 2A-2B provides an overview of how the scrubber is used. In FIG. 2A the scrubber is inserted through the narrow opening of ajar that is partially filled with a liquid cleaning solution. In FIG. 2B the top of the jar is covered and the jar is shaken back-and-forth and up-and-down to force the scrubber against the inside surfaces of the jar. The more vigorously the jar is shaken the greater the amount of cleaning action provided by the scrubber. The scrubber is removed from the jar by simply turning it upside down and allowing it to slip out with the draining cleaning solution.

### Experiments

Several experiments were performed to determine relationships among scrubber component dimensions, materials used, scrubber stiffness, scrubber wear and cleaning efficiency. These experiments are described and summarized in the following graphs.

### Test of Materials Providing Reasonable Flexibility for the Tube or Sheath

A variety of scrubbing materials were evaluated and a material made from polypropylene was selected for test trials. This material is commercially available and consists of a multifilament polypropylene base fabric interwoven with monofilament polypropylene threads that extend out and create the abrasive scrubbing surface. This material is durable and resistant to abrasion, low in moisture absorbency, flexible, and easily fashioned into the sock required for the scrubber. It was determined that the sock or tube was best formed by sewing or heat-sealing at least two edges together. Early tests indicated that the density of the weave and the location and type of seam or seams required to form the sock could effect its flexibility and so some simple experiments were undertaken to determine the best combination of features for its' construction.

To assess flexibility a simple test was devised using a procedure similar to that found in the paper industry to rate the stiffness of paper or board. In the “3-Point Method” a board is placed on top of two blades separated by a specific distance. A third knife blade applies force to the top of the board midway between the two end blades. The degree of deflection or arc at the center of the board for a given applied force is used to derive the stiffness index. The experiment utilizes a knife blade facing upward at 0 degrees and placed at the center of a cardboard circle. The circle is marked into its 360-degree radii. The scrubber being tested is draped over the knife blade at its center with the seam facing outward at a 90-degree angle to the knife blade. Unlike the procedure for testing paper it is not force applied to the knife blade that creates an arc in the scrubber but rather gravity which provides a constant force on the two ends of the scrubber resulting in a downward sloping of the ends and arcing in the middle. The points at which the ends of the scrubber intersect the edges of the circle define the two endpoints of the major arc being measured. In this experiment the greater the arc is the less the stiffness is. The results of this experiment are presented in Graph 1 as a stiffness rating for scrubbers of different lengths constructed using different cloth weaves, seams, and balls.

Scrubbers containing 9.525 mm balls and 4.5 mm balls were constructed using socks with outside diameters of 2.0 cm. The socks containing the 6.35 mm balls had outside diameters of 1.2 cm. Scrubbers containing the 9.525 mm and 6.35 mm balls were constructed by arranging the balls end-to-end as in FIG. 1A. Scrubbers constructed using the 4.5 mm balls were constructed by filling the 2 cm sock with the smaller balls in a fashion similar to a sandbag as shown in FIG. 1B.

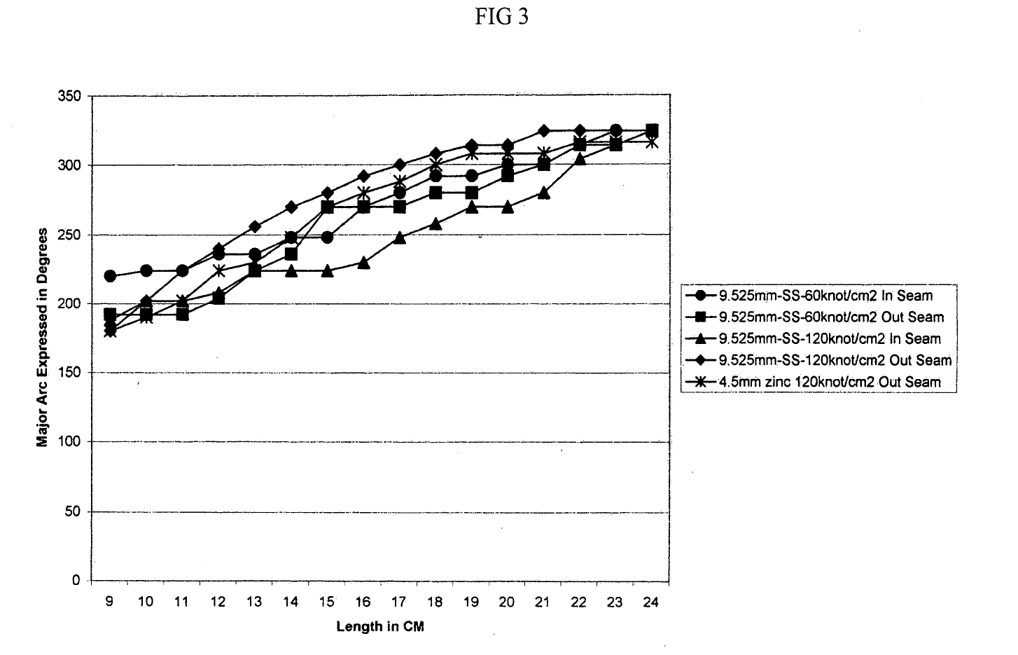

The graph in FIG. 3 shows that as length increases all combinations of scrubbing material, seam type, and ball size result in increased flexibility. It is also clear that scrubbers made using cloth with 120 knots/cm² are less flexible than those made with cloth of 60 knot/cm² at all lengths less than 22 cm. It can also be observed that generally the scrubbers with the outside seam are less flexible than those with the inside seam although the effect is clearly greater for those made with the 120 knot/cm² than for those made with the 60 knot/cm² fabric.

Experiments were undertaken to evaluate the effect that stiffness had on the tendency for the scrubber to tangle in use. In our design we determined that as a consumer product the scrubber must be easily removed from the container being cleaned without tangling since in some containers tangling could make removal impossible or result in damage to the container being cleaned. To evaluate tangle we performed an experiment using a standard 750 ml bottle with an 8 cm tall neck and a 2 cm diameter opening. The bottle was filled with 250 ml of water and a scrubber inserted into the bottle and shaken vigorously for 30 seconds. At the end of 30 seconds the bottle was turned over in one motion and the water drained. If the scrubber slipped out of the bottle with the water without shaking or manipulation it was considered a non-tangle (NT) event. If, however, the scrubber did not slip out easily with the water and had to be removed by additional shaking or physical manipulation then it was considered a tangle (T) event. The process of inserting and removing the scrubber from the bottle was repeated 100 times for each of the combinations of weighted objects, fabrics, and scrubber lengths ranging from 35 cm to 10 cm.

From the analysis it was concluded, for a bag having a plurality of objects, and a width of two centimeters, that T, the number of tangles (a tangle event) is related to the length, L of the scrubber; G is the weight of the bag in grams; D the diameter of the opening of a container; and F, the flexibility rating (according to the test protocol described above), by the equation:

T=0.980−(L0.061)+(G0.018)−(D0.29)+(F0.002).

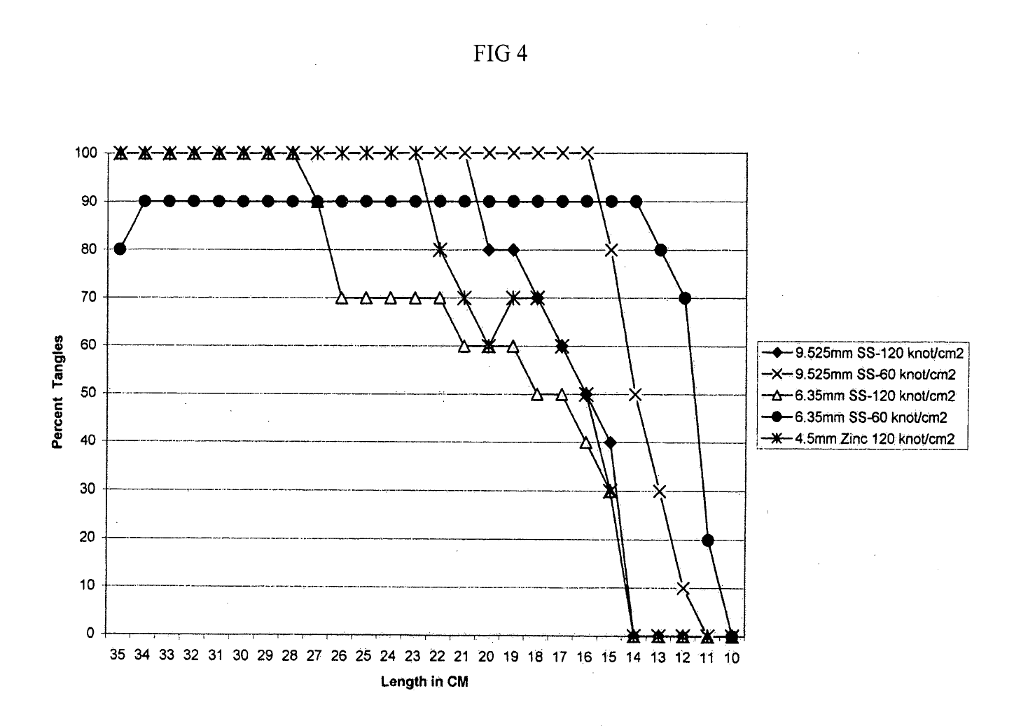

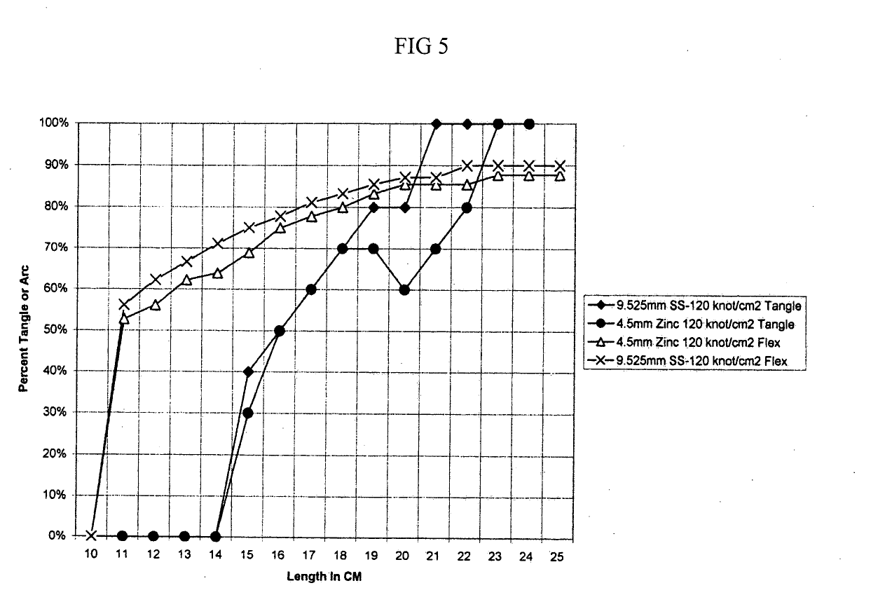

The graph in FIG. 4 presents the results of the tangle analysis experiments for scrubbers fabricated using a variety of different sized stainless steel or zinc plated steel balls, fabric weaves, and lengths. In these experiments all socks were constructed with outside seams because flexibility ratings for outside seams (FIG. 3) were good and the use of an outside seam simplifies the manufacturing process.

From FIG. 4 it is clear that there are significant differences between the various combinations of steel balls, fabrics, and lengths. Generally as the length of the scrubber decreased the tendency for it to tangle decreased. The density of the weave of the polypropylene sock exerted the greatest influence of any variable on tangle. That is, all three ball sizes and weights produced less tangle when encased in the high density weave sock than when encased in the low density weave sock. The combination that produced the least tangle was the ⅜-inch ball encased in the 120 knot/cm² sock.

The relationship between the flexibility rating and the propensity of the scrubber to tangle can be more easily seen in graph in FIG. 5. Because of the potential impact of problems caused when the scrubber tangles inside of containers our original designed required that the scrubber have no tangle problems in the test bottle. FIG. 5 reveals that scrubbers made using the 9.525 mm and the 4.5 mm weights both reached the point of no tangles at a length of 14 cm or when the flexibility ratings were between 60% and 70%.

### Scrubber Wear and Flexibility

A further experiment was undertaken to determine the effect that continued use of the scrubber might have on its flexibility, and correspondingly, if reductions in stiffness related to wear increased the tendency to tangle. In this simple experiment several scrubbers were placed in a large motorized tumbler without liquid and tumbled continuously for a period of five hours. These conditions are very harsh since there is no liquid to buffer the impact of the scrubber against the side of the tumbler and the large diameter tumbler allowed the scrubber to drop or fall up to 30″ before impact against its side. It is estimated that this test was equivalent to using the scrubber to clean over 300 bottles or jars. Stiffness was measured before and after tumbling. Only scrubber's constructed using 9.525 mm stainless balls encased in the 120 knot/cm² fabric were used.

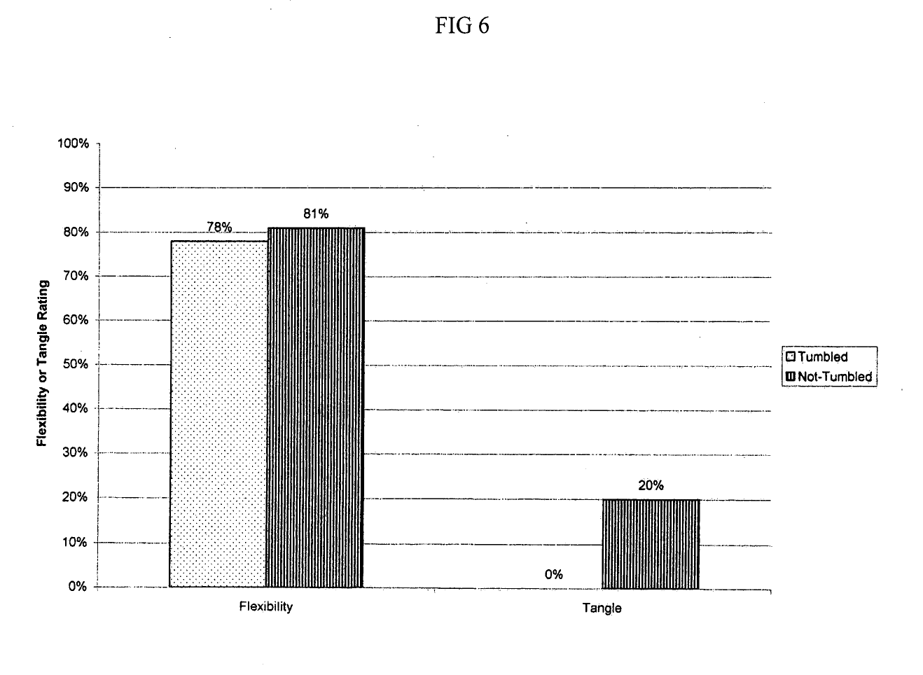

The results of the above experiment are presented in graph in FIG. 6. FIG. 6 reveals that the tumbling did not significantly increase the flexibility rating or the tangle factor for the scrubbers made with the 9.525 mm balls. It should be noted that the effect of the tumbling did significantly reduce the scrubbing threads and texture of the scrubbers. Thus scrubbers constructed using the 120 knot/cm² polypropylene fabric may be expected to wear out its scrubbing surface without failing mechanically or significantly increasing its risk of tangling.

### CONCLUSION, RAMIFICATION, AND SCOPE OF INVENTION

Thus the reader will see that the hollow ware scrubber provides a reliable, easy to use, and very effective device, for scrubbing a wide range of hollow ware in the home or in industrial settings. The device has a large surface area that can be fabricated from a broad range of materials that can scrub, dry, or polish the inside of hollow vessels. The unique use of weighted balls or objects inside of the cleaning tube provides adequate flexibility for cleaning while ensuring the device does not become tangled or kinked, and further the tube of material cushions the inside of the containers from the impact of the balls.

While the above description contains much specificity, these should not be construed as limitations on the scope of the invention, but rather as an exemplification of one preferred embodiment thereof. Many other variations are possible. For example the scrubber may contain objects of different shapes, or, shapes and sizes may be varied within the tube. The tube of material encasing the weighted objects may be formed from different textures, colors, and compositions of materials. The scrubber may be fabricated in such a manner that two or more individual scrubbers could be joined together to create a larger scrubbing or polishing surface for large vessels. A wide variety of ornamental designs may be added to the scrubber to improve its' marketability or consumer appeal.

Accordingly, the scope of the invention should be determined not by the embodiment(s) illustrated, but by the appended claims and their legal equivalents.

We claim:

1. A device configured to be inserted within and for cleaning inside a container having a point Q inside said container, the device comprising:
a flexible sheath, wherein P is any point on the surface of the sheath; and
at least one solid object contained by the sheath;
whereby the device is inserted into the container, the container is agitated, causing P to exert a force against Q.

2. The device of claim 1, wherein the sheath contains a cleaning agent released by the agitation.

3. The device of claim 1, wherein the object is made from a material selected from the group consisting of glass beads and metal epoxy hybrid.

4. The device of claim 1, wherein the sheath is made in a decorative shape.

5. A device for cleaning inside a container, the device comprising:
a flexible object, the object conformable to the bottom of the container;
whereby the device is inserted into the container, the container is agitated, causing the device to exert a force against the container and clean the container.

6. The device of claim 5, wherein the flexible object has cleaning material, and when the container is agitated, the flexible object releases cleaning material.

7. A method for cleaning inside a container, the method comprising:
providing a device configured to be inserted completely into the container, the device having a flexible sheath, the sheath having cleaning material, a textured surface and containing a solid object;
inserting the device into the container; and
agitating the container;
whereby the force of agitation causes the object to release cleaning material, and to react against the textured surface, causing the textured surface and cleaning material to scour the inside of the container.
